(19) United States
(12) Patent Application Publication
(10) Pub. No.: US 2008/0093931 A1
(43) Pub. Date: Apr. 24, 2008

(54) POWER SUPPLY VOLTAGE GENERATING CIRCUIT AND SEMICONDUCTOR INTEGRATED CIRCUIT DEVICE

(75) Inventor: Soichiro YOSHIDA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: ELPIDA MEMORY, INC., Tokyo (JP)

(21) Appl. No.: 11/875,235

(22) Filed: Oct. 19, 2007

(30) Foreign Application Priority Data
Oct. 24, 2006 (JP) 2006-288692

(51) Int. Cl. H02J 1/00

(52) U.S. Cl. 307/80

(57) ABSTRACT

Required minimum power supply voltage for a load circuit is maintained. Power supply voltage generating circuit 10 comprises a power supply circuit 11 that steps down a voltage of an external power supply VCC based on a reference voltage VREF and supplies it to a power supply VINT of a load circuit 14, and a power supply circuit 12 that steps down a voltage of a step-up voltage power supply VPP based on a reference voltage VREF-ΔV, which is closer to the ground potential than the reference voltage VREF, and supplies it to the power supply VINT of the load circuit 14. The power supply circuit 12 supplies power to the power supply VINT of the load circuit 14 when the voltage of the power supply VINT is below the reference voltage VREF-ΔV. Further, a voltage step-up power supply circuit 13 generates a step-up power supply voltage VPP, which is a voltage higher than the voltage of the external power supply VCC, and supplies it to the power supply circuit 12. The load circuit 14 is comprised of various circuits operated by the power supply VINT.

### REFERENCE TO RELATED APPLICATION

The present application is claiming the priority of the earlier Japanese patent application No. 2006-288692 filed on Oct. 24, 2006, the entire disclosure thereof being incorporated herein by reference thereto.

### FIELD OF THE INVENTION

The present invention relates to a power supply voltage generating circuit and semiconductor integrated circuit device, and particularly to a power supply voltage generating circuit that steps down an external supply voltage to a predetermined internal supply voltage and to a semiconductor integrated circuit device comprising the same.

### BACKGROUND OF THE INVENTION

In recent years, in semiconductor integrated circuit devices such as semiconductor memory devices, an internal step-down power supply voltage that does not depend on an external supply voltage is generated based on the external supply voltage and used, in order to reduce current consumption and the influence of fluctuations in external supply voltage. For instance, an internal supply voltage generating circuit capable of stably generating an internal supply voltage aiming at superior high-frequency response characteristics is described in Patent Document 1. Further, a semiconductor integrated circuit device capable of reducing power consumption without decrease in the sensing operation rate and without supply of charges more than necessary to memory cells is described in Patent Document 2.

[Patent Document 1]

Japanese Patent Kokai Publication No. JP-P2005-174351A

[Patent Document 2]

Japanese Patent Kokai Publication No. JP-P2002-334577A

### SUMMARY OF THE DISCLOSURE

The following analysis is given by the present invention. The disclosure of the above-mentioned Patent Documents 1 and 2 is herein incorporated by reference thereto.

When a battery is used as an external power supply and an internal step-down potential is set so that sufficient current is supplied to an external supply potential, there may be cases where the voltage becomes too low and it is difficult to meet the demand for low voltage and high-speed operation. In other words, when a set value for the generated internal step-down voltage is near the minimum value of the external supply voltage in an internal voltage generating circuit, the current supply capability of an amplifier that supplies power decreases. Because of this, sufficient current cannot be supplied during the operation of circuits (load circuits) connected to the internal step-down power supply and the internal step-down potential may drop. Therefore, it is necessary to have a sufficient potential difference between the external supply voltage and the internal step-down power supply voltage so that the required current supply capability can be obtained. Otherwise, for instance, when a battery is used as an external power supply, the expected life of the battery may be shortened.

It is an object of the present invention to provide a power supply voltage generating circuit and semiconductor integrated circuit device capable of maintaining a voltage in an internal voltage generating circuit even when an external supply voltage is below the minimum value. Other objects will become apparent in the entire disclosure including the drawings and claims.

A power supply voltage generating circuit relating to an aspect of the present invention comprises: a first power supply circuit that steps down an external power supply voltage based on a first reference voltage and supplies the result to a load power supply of a load circuit; and a second power supply circuit that steps down a step-up power supply voltage, stepped up from the external power supply voltage, based on a second reference voltage, which is closer to the ground potential than the first reference voltage, and supplies the result to the load power supply. The second power supply circuit supplies power to the load power supply in place of the first power supply circuit when the voltage of the load power supply is below the second reference voltage.

In a first development mode of the power supply voltage generating circuit, it is preferable that the first power supply circuit includes a first differential amplifier circuit that compares a voltage of the load power supply with the first reference voltage and outputs an amplified output, and a first output stage circuit, driven by the first differential amplifier circuit, that steps down the external power supply voltage and supplies the result to the load power supply; and the second power supply circuit includes a second differential amplifier circuit that compares a voltage of the load power supply with the second reference voltage and outputs an amplified output, and a second output stage circuit, driven by the second differential amplifier circuit, that steps down the step-up power supply voltage and supplies the result to the load power supply.

In a second development mode of the power supply voltage generating circuit, it is preferable that the first output stage circuit be constituted by a first field effect transistor of a first conductivity type having its gate connected to an output end of the first differential amplifier circuit, the external power supply voltage applied to its source, and its drain connected to the load power supply; and the second output stage circuit be constituted by a second field effect transistor of a first conductivity type having its gate connected to an output end of the second differential amplifier circuit, the step-up power supply voltage applied to its source, and its drain connected to the load power supply.

In a third development mode of the power supply voltage generating circuit, it is preferable that the first output stage circuit further comprise first two resistance elements serially connected between the drain of the first field effect transistor of the first conductivity type and the ground; a connection point of the first two resistance elements be connected to an inverting input terminal of the first differential amplifier circuit; the second output stage circuit further comprise second two resistance elements serially connected between the drain of the second field effect transistor of the first conductivity type and the ground; and a connection point of the second two resistance elements be connected to an inverting input terminal of the second differential amplifier circuit.

In a fourth development mode of the power supply voltage generating circuit, it is preferable that the first output stage circuit further comprise: a first field effect transistor of the second conductivity type diode-connected and inserted between the drain of the first field effect transistor of the first conductivity type and the first two resistance elements, and the second field effect transistor of a second conductivity type having its gate connected to the drain of the first field effect transistor of the first conductivity type, and the external power supply voltage applied to its drain; the second output stage circuit further comprise: a third field effect transistor of the second conductivity type diode-connected and inserted between the drain of the second field effect transistor of the first conductivity type and the second two resistance elements, and a fourth field effect transistor of the second conductivity type having its gate connected to the drain of the second field effect transistor of the first conductivity type, and the step-up power supply voltage applied to its drain; and sources of the second and fourth field effect transistors of the second conductivity type be connected to the load power supply instead of connecting the drains of the first and second field effect transistors of a first conductivity type to the load power supply.

In another aspect of the present invention, there is provided a semiconductor integrated circuit device comprising the power supply voltage generating circuit, a voltage step-up power supply circuit that generates the step-up power voltage, and a load circuit.

The meritorious effects of the present invention are summarized as follows.

According to the present invention, even when an external power supply voltage is below a required minimum value, a required minimum power supply voltage for a load circuit can be maintained because a step-up power supply voltage stepped up from an external power supply voltage is stepped down and supplied to the load circuit.

### BRIEF DESCRIPTION OF THE DRAWINGS

FIG. 1 is a block diagram showing the configuration of a semiconductor integrated circuit device relating to an example of the present invention.

FIG. 2 is a drawing schematically showing voltage fluctuation waveforms of an internal power supply in a power supply voltage generating circuit.

FIG. 3 is a circuit diagram of a power supply voltage generating circuit relating to a first example of the present invention.

FIG. 4 is a circuit diagram of a power supply voltage generating circuit relating to a second example of the present invention.

FIG. 5 is a circuit diagram of a power supply voltage generating circuit relating to a third example of the present invention.

### PREFERRED MODES OF THE INVENTION

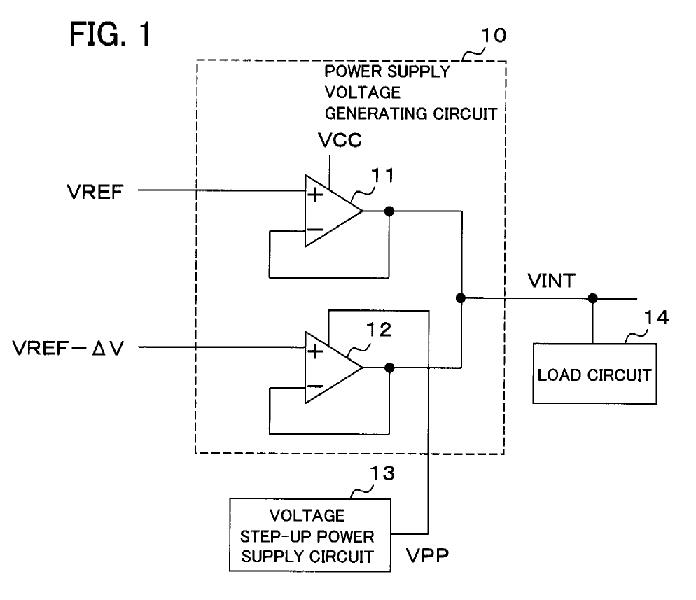

FIG. 1 is a block diagram showing the configuration of a semiconductor integrated circuit device relating to an example of the present invention. In FIG. 1, the semiconductor integrated circuit device comprises a power supply voltage generating circuit 10, a voltage step-up power supply circuit 13, and a load circuit 14. The power supply voltage generating circuit 10 comprises a first power supply circuit 11 that steps down a voltage of an external power supply VCC based on a reference voltage VREF and supplies it to a power supply VINT of the load circuit 14, and a second power supply circuit 12 that steps down a voltage of a step-up voltage power supply VPP based on a reference voltage VREF-ΔV, which is closer to the ground potential than the reference voltage VREF, and supplies it to the power supply VINT of the load circuit 14. The power supply circuit 12 supplies power to the power supply VINT of the load circuit 14 when the power supply voltage of the load circuit 14 is below the reference voltage VREF-ΔV. Further, the voltage step-up power supply circuit 13 generates the step-up power supply voltage VPP, which is a voltage higher than the voltage of the external power supply VCC, and supplies it to the second power supply circuit 12. The load circuit 14 is comprised of various circuits operated by the power supply VINT.

In the semiconductor integrated circuit device configured as described, a set value for the power supply VINT, which is an internal step-down voltage, i.e., the reference voltage VREF, is set to a value near the minimum value (VCCmin) of the voltage of the external power supply VCC. If the voltage of the external power supply VCC drops for some reason, the first power supply circuit 11 will not be able to supply sufficient current to the load circuit 14 connected to the power supply node VINT during its operation. However, when the potential of the power supply node VINT becomes below the reference voltage VREF-ΔV, the second power supply circuit 12 is turned on and the step-up voltage power supply VPP is supplied to the power supply node VINT. This power supply circuit 12 has sufficient current supply capability and is capable of maintaining at least the voltage of the power supply node VINT at the reference voltage VREF-ΔV by having the step-up voltage power supply VPP with a voltage higher than the voltage of the external power supply VCC supply power to the power supply node VINT.

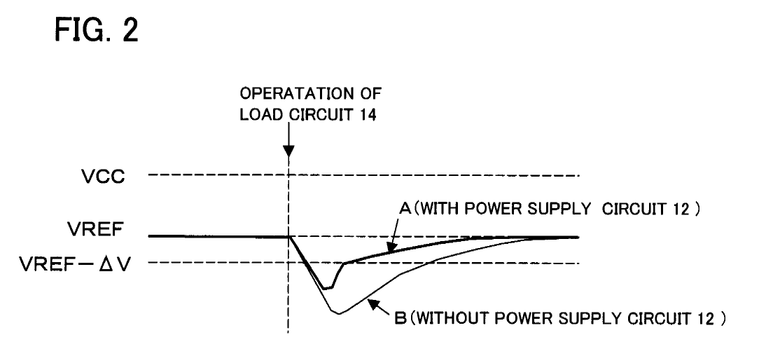

Next, the operation waveforms of the power supply voltage generating circuit 10 will be described. FIG. 2 is a drawing schematically showing voltage fluctuation waveforms of the internal power supply in the power supply voltage generating circuit 10. Waveform examples relating to the IR drop of the power supply VINT when the load circuit 14 connected to the power supply VINT is operated by the first and second power supply circuits 11 and 12 are shown. When the voltage of the power supply VINT becomes below the reference voltage VREF-ΔV, the second power supply circuit 12 is turned on. At this time, the second power supply circuit 12 has sufficient current supply capability to provide for the current consumption since it is connected to the internal step-up voltage power supply VPP. Therefore, the voltage of the power supply VINT immediately returns to the reference voltage VREF-ΔV. Further, after the second power supply circuit 12 is turned off, the first power supply circuit 11 will slowly bring the voltage of the power supply VINT back to the reference voltage VREF if it has sufficient current supply capability (A in FIG. 2).

On the other hand, in the case where the second power supply circuit 12 does not exist, when the potential difference between the voltages of the external power supply VCC and the power supply VINT becomes small and the current supply capability of the first power supply circuit 11 decreases, the first power supply circuit 11 cannot sufficiently provide for the current consumed by the circuit group connected to the power supply node VINT during their operation. In this case, the IR drop at the power supply node VINT becomes large and the return to the reference voltage is slow. As a result, a malfunction may occur and the required operation speed may not be realized (B in FIG. 2).

As described above, in the power supply voltage generating circuit 10, when the IR drop of the voltage of the power supply VINT occurs during the operation of the load circuit 14 connected to the power supply node VINT, the second power supply circuit 12 immediately brings the voltage back to the reference voltage VREF-ΔV. Therefore, the load circuit 14 is less likely to malfunction and a higher speed operation is possible. The power supply generating circuit will be further described in detail using examples.

### EXAMPLE 1

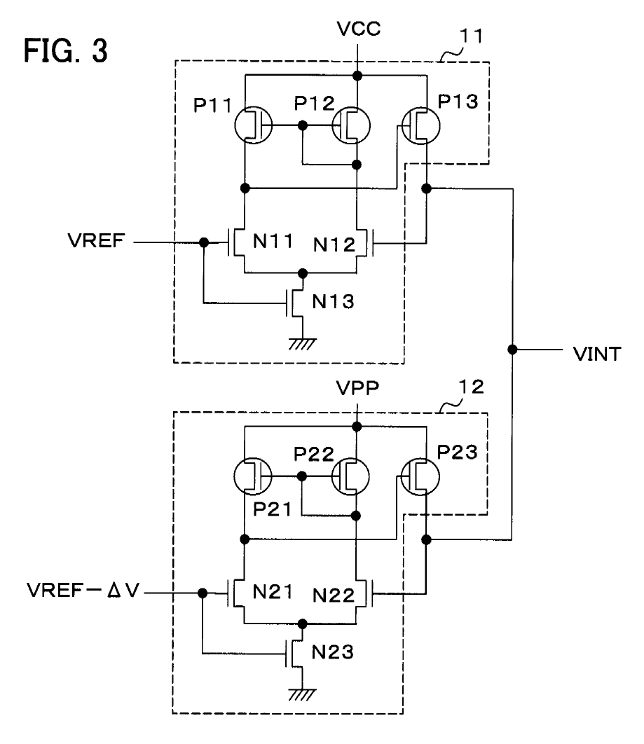

FIG. 3 is a circuit diagram of a power supply voltage generating circuit relating to a first example of the present invention. In FIG. 3, the same symbols as the ones in FIG. 1 indicate the same things. The first power supply circuit 11 comprises PMOS transistors P11, P12, and P13, and NMOS transistors N11, N12, and N13. Sources of the NMOS transistor N11, having a gate to which the reference voltage VREF is applied, and the NMOS transistor N12, having a gate to which the power supply (voltage) VINT is applied, are connected in common to a drain of the NMOS transistor N13. The reference voltage VREF is applied to a gate of the NMOS transistor N13 while its source is grounded. A drain of the NMOS transistor N11 is connected to a drain of the PMOS transistor P11 and a gate of the PMOS transistor P13. A drain of the NMOS transistor N12 is connected to a gate of the PMOS transistor P11 and a gate and drain of the PMOS transistor P12. The external power supply VCC is connected to each source of the PMOS transistors P11, P12 and P13. A drain of the PMOS transistor P13 is connected to the power supply node VINT.

In the first power supply circuit 11 configured as described above, the NMOS transistors N11 and N12, having the PMOS transistor P11 and the PMOS transistor P12 as a load respectively, constitute a differential amplifier to which the voltage of the power supply node VINT is fed back, and the PMOS transistor P13 forms an output stage. The external power supply VCC supplies current to the power supply node VINT so that the voltage of the power supply node VINT is equal to the reference voltage VREF.

Further, the second power supply circuit 12 comprises PMOS transistors P21, P22, and P23, and NMOS transistors N21, N22, and N23. In the second power supply circuit 12, the PMOS transistors P21, P22, and P23, and the NMOS transistors N21, N22, and N23, respectively, correspond to the PMOS transistors P11, P12, and P13, and the NMOS transistors N11, N12, and N13 in the first power supply circuit 11 and are configured identically. However, the reference voltage VREF-ΔV is applied instead of the reference voltage VREF, and the step-up voltage power supply VPP is applied instead of the external power supply VCC, in the second power supply circuit 12.

In the second power supply circuit 12 configured as described above, the NMOS transistors N21 and N22, having the PMOS transistor P21 and the PMOS transistor P22 as a load respectively, constitute a differential amplifier to which the voltage of the power supply node VINT is fed back, and the PMOS transistor P23 forms an output stage. When the voltage of the power supply node VINT is equal to the reference voltage VREF, the PMOS transistor P23 is turned off and there is no current flowing from the step-up voltage power supply VPP to the power supply node VINT. On the other hand, when the voltage of the power supply node VINT is below the reference voltage VREF-ΔV, the step-up voltage power supply VPP supplies current to the power supply VINT so that the voltage of the power supply VINT is equal to the reference voltage VREF-ΔV.

The power supply voltage generating circuit configured as described above is capable of maintaining the minimum power supply voltage for the load circuit because it steps down the voltage of the step-up voltage power supply VPP and supplies it to the power supply node VINT of the load circuit when the voltage of the external power supply VCC is below the required minimum value.

### EXAMPLE 2

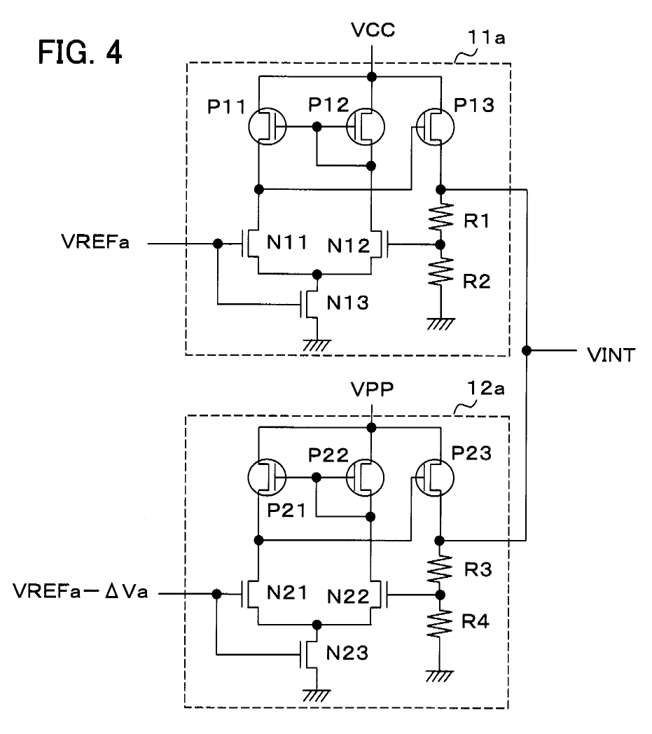

FIG. 4 is a circuit diagram of a power supply voltage generating circuit relating to a second example of the present invention. In FIG. 4, the same symbols as the ones in FIG. 3 indicate the same elements, thus the explanations of them will be omitted. Unlike FIG. 3, in the power supply voltage generating circuit in FIG. 4, a serially connected circuit of resistances R1 and R2 is inserted between the drain of the PMOS transistor P13 and the ground in a first power supply circuit 11a, and the gate of the NMOS transistor N12 is connected to a connection point of the resistances R1 and R2. A reference voltage VREFa is applied to a gate of the NMOS transistor N11. Further, a serially connected circuit of resistances R3 and R4 is inserted between a drain of the PMOS transistor P23 and the ground in a second power supply circuit 12a, and a gate of the NMOS transistor N22 is connected to a connection point of the resistances R3 and R4. A reference voltage VREFa-ΔV is applied to a gate of the NMOS transistor N21.

In the power supply voltage generating circuit configured as described above, the reference voltage VREFa and the reference voltage VREFa-ΔV can be set lower than the voltage of the power supply VINT by setting the resistance ratios between the resistances R1 and R2 and between the resistances R3 and R4. For instance, when a desired voltage of the power supply node VINT is Vint and VREFa=Vint/2, Vint=VREFa×2 can be obtained by setting R1=R2. In the power supply circuit 12a, when a reference voltage ΔVa lower than VREFa is supplied, and by configuring the power supply circuit 12a with the ratio between the resistances R3 and R4 so that it outputs a predetermined step-down voltage (VREFa−ΔVa), Example 2 operates identically to Example 1 and the same effects can be obtained. In the power supply voltage generating circuit described above, the voltage of the power supply node VINT can be set to a desired voltage by setting the reference voltage VREFa low even in cases where it is difficult to generate a stable reference potential VREFa very close to the voltage of the external power supply VCC.

### EXAMPLE 3

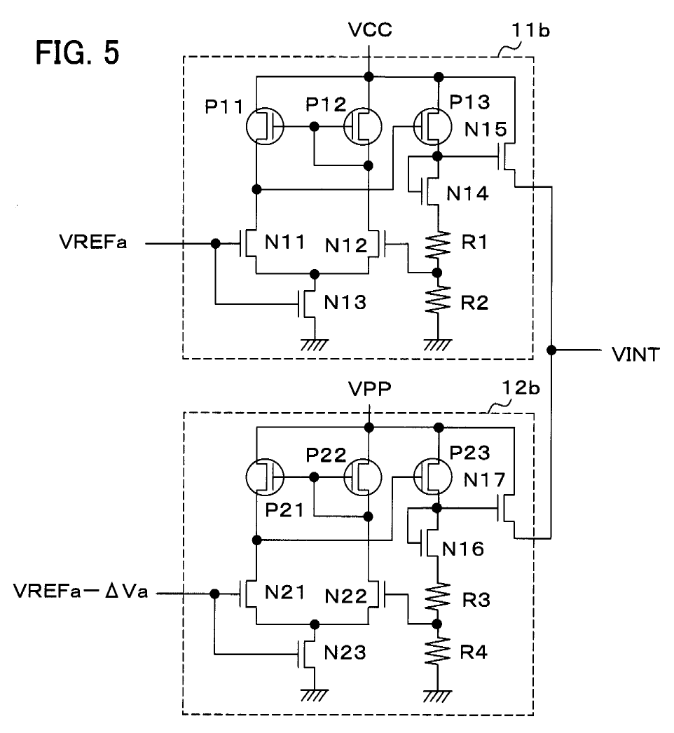

FIG. 5 is a circuit diagram of a power supply voltage generating circuit relating to a third example of the present invention. In FIG. 5, the same symbols as the ones in FIG. 4 indicate the same elements, thus the explanations of them will be omitted. Unlike FIG. 4, the power supply voltage generating circuit in FIG. 5 comprises an NMOS transistor N14 diode-connected between the drain of the PMOS transistor P13 and the resistance R1 in a first power supply circuit 11b. It further comprises an NMOS transistor N15 having its gate connected to the drain of the PMOS transistor P13, its drain connected to the external power supply VCC, and its source connected to the power supply node VINT. Further, the power supply voltage generating circuit in FIG. 5 comprises an NMOS transistor N16 diode-connected between the drain of the PMOS transistor P23 and the resistance R3 in a second power supply circuit 12b in which there is an NMOS transistor N17 having its gate connected to the drain of the PMOS transistor P23, its drain connected to the step-up voltage power supply VPP, and its source connected to the power supply node VINT.

In Examples 1 and 2, transistors that function as the driver for the output stage of the power supply voltage generating circuit are PMOS transistors, however, the same effects as Examples 1 and 2 can be obtained when NMOS transistors are used as shown in FIG. 5.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A power supply voltage generating circuit comprising:
a first power supply circuit that steps down an external power supply voltage based on a first reference voltage and supplies the result to a load power supply of a load circuit; and
a second power supply circuit that steps down a step-up power supply voltage, stepped up from said external power supply voltage, based on a second reference voltage, which is closer to the ground potential than said first reference voltage, and supplies the result to said load power supply; wherein
said second power supply circuit supplies power to said load power supply in place of said first power supply circuit when the voltage of said load power supply is below said second reference voltage.

2. The power supply voltage generating circuit as defined in claim 1, wherein
said first power supply circuit includes a first differential amplifier circuit that compares a voltage of said load power supply with said first reference voltage and outputs an amplified output, and a first output stage circuit, driven by said first differential amplifier circuit, that steps down said external power supply voltage and supplies the result to said load power supply; and
said second power supply circuit includes a second differential amplifier circuit that compares a voltage of said load power supply with said second reference voltage and outputs an amplified output, and a second output stage circuit, driven by said second differential amplifier circuit, that steps down said step-up power supply voltage and supplies the result to said load power supply.

3. The power supply voltage generating circuit as defined in claim 2, wherein said first output stage circuit is constituted by a first field effect transistor of a first conductivity type having its gate connected to an output end of said first differential amplifier circuit, said external power supply voltage applied to its source, and its drain connected to said load power supply; and
said second output stage circuit is constituted by a second field effect transistor of a first conductivity type having its gate connected to an output end of said second differential amplifier circuit, said step-up power supply voltage applied to its source, and its drain connected to said load power supply.

4. The power supply voltage generating circuit as defined in claim 3, wherein said first output stage circuit further comprises first two resistance elements serially connected between the drain of said first field effect transistor of the first conductivity type and the ground;
a connection point of the first two resistance elements is connected to an inverting input terminal of said first differential amplifier circuit;
said second output stage circuit further comprises second two resistance elements serially connected between the drain of said second field effect transistor of the first conductivity type and the ground; and
a connection point of the second two resistance elements is connected to an inverting input terminal of said second differential amplifier circuit.

5. The power supply voltage generating circuit as defined in claim 3, wherein
said first output stage circuit further comprises: a first field effect transistor of the second conductivity type diode-connected and inserted between the drain of said first field effect transistor of the first conductivity type and said first two resistance elements, and
a second field effect transistor of the second conductivity type having its gate connected to the drain of said first field effect transistor of the first conductivity type, and said external power supply voltage applied to its drain;
said second output stage circuit further comprises: a third field effect transistor of the second conductivity type diode-connected and inserted between the drain of said second field effect transistor of the first conductivity type and said second two resistance elements, and
a fourth field effect transistor of the second conductivity type having its gate connected to the drain of said second field effect transistor of the first conductivity type, and said step-up power supply voltage applied to its drain; and
sources of said second and fourth field effect transistors of a second conductivity type are connected to said load power supply instead of connecting the drains of said first and second field effect transistors of a first conductivity type to said load power supply.

6. A semiconductor integrated circuit device comprising the power supply voltage generating circuit as defined in claim 1, a voltage step-up power supply circuit that generates said step-up power supply voltage, and said load circuit.

7. A semiconductor integrated circuit device comprising the power supply voltage generating circuit as defined in claim 2, a voltage step-up power supply circuit that generates said step-up power supply voltage, and said load circuit.

8. A semiconductor integrated circuit device comprising the power supply voltage generating circuit as defined in claim 3, a voltage step-up power supply circuit that generates said step-up power supply voltage, and said load circuit.

9. A semiconductor integrated circuit device comprising the power supply voltage generating circuit as defined in claim 4, a voltage step-up power supply circuit that generates said step-up power supply voltage, and said load circuit.

10. A semiconductor integrated circuit device comprising the power supply voltage generating circuit as defined in claim 5, a voltage step-up power supply circuit that generates said step-up power supply voltage, and said load circuit.
